(19) United States
(12) Patent Application Publication
(10) Pub. No.: US 2022/0202000 A1
(43) Pub. Date: Jun. 30, 2022

(54) MOUNTABLE STAND ASSEMBLY

(71) Applicant: 365 Outdoor Gear, LLC, Richardson, TX (US)

(72) Inventor: Robert Lee Taylor, Irving, TX (US)

(21) Appl. No.: 17/645,922

(22) Filed: Dec. 23, 2021

Related U.S. Application Data
(60) Provisional application No. 63/130,463, filed on Dec. 24, 2020.

(51) Int. Cl. A01K 97/22

(52) U.S. Cl. CPC A01K 97/22

(57) ABSTRACT

A mountable stand assembly comprises a body including a first side support frame, a second side support frame, a front side support frame coupled between the first side support frame and the second side support frame, and a standing surface coupled to each of the first side support frame, the second side support frame, and the front side support frame such that the standing surface is disposed above the first side support frame, the second side support frame, and the front side support frame. The standing surface includes a foot passage formed on a rear side of the standing surface, and a raised edge bent upward from an outer edge of each of the rear side, a front side, a left side, and a right side of the standing surface.

### CROSS-REFERENCE TO RELATED APPLICATIONS

This application claims priority to and the benefit of U.S. Provisional Patent Application No. 63/130,463, filed Dec. 24, 2020, entitled MOUNTABLE STAND ASSEMBLY, the entire contents of which are herein incorporated by reference.

### TECHNICAL FIELD

The present disclosure relates generally to mountable platforms. More specifically, this disclosure relates to a stand assembly that can be mounted to a structure, such as a fishing boat and used in conjunction with a trolling motor pedal.

### BACKGROUND

When fishing for fish such as bass, fishermen and fisherwomen (“fishers”) typically stand at a front end of their fishing boat and look for bass swimming close to the surface of the water. While scouting for fish near the surface of the water, fishers will stand on top of various objects such as stools, chairs, ice chests, or any other readily available objects to give them a more advantageous vantage point.

Standing on stools or other objects not meant to be fished from can be dangerous. The object is not secured to the boat and is therefore unstable. The top surface of the object on which the fisher stands is not meant for standing and does not provide any structure to prevent the fisher from slipping or stepping off the object.

Additionally, when the fisher is standing on top of the elevated object, he is unable to operate the boat's trolling motor. A trolling motor is a secondary motor mounted to the bow of the boat and used by the fisher to move the boat closer to a group of identified fish. The fisher does not have access to the trolling motor operating pedal when he is standing on the elevated object. Accordingly, currently, a fisher must stand on his elevated object to identify where fish are, then step off the elevated object to operate the trolling motor pedal to approach the fish. This routine of having to go back and forth between the elevated object and the trolling motor pedal may have to be repeated by the fisher multiple times before he is in a position to cast his line at the identified fish.

### SUMMARY

The present disclosure provides a mountable stand assembly that can be mounted to a structure to provide a user with an alternate vantage point.

In various embodiments, a mountable stand assembly comprises a body including a first side support frame, a second side support frame, a front side support frame coupled between the first side support frame and the second side support frame, and a standing surface coupled to each of the first side support frame, the second side support frame, and the front side support frame such that the standing surface is disposed above the first side support frame, the second side support frame, and the front side support frame. The standing surface includes a foot passage formed on a rear side of the standing surface, and a raised edge bent upward from an outer edge of each of the rear side, a front side, a left side, and a right side of the standing surface.

In various embodiments, the first side support frame, the second side support frame, the front side support frame, and the standing surface each has a generally rectangular shape.

In various embodiments, the first side support frame includes a first flanged surface bent in a first inward direction from a bottom portion of the first side support frame towards a center portion of the body.

In various embodiments, the second side support frame includes a second flanged surface bent in a second inward direction from a bottom portion of the second side support frame towards the center portion of the body.

In various embodiments, the front side support frame includes a third flanged surface disposed on a first side of the front side support frame adjacent to the first side support frame, the third flanged surface bent inward from the first side of the front side support frame toward the center portion of the body, and a fourth flanged surface disposed on a second side of the front side support frame adjacent to the second side support frame, the fourth flanged surface bent inward from the second side of the front side support frame toward the center portion of the body.

In various embodiments, the front side support frame includes a trolling motor passage formed along a bottom side of the front side support frame.

In various embodiments, the trolling motor passage is formed as a semi-circular cutout.

In various embodiments, the foot passage is formed as a U-shaped cutout.

In various embodiments, the mountable stand assembly is operable for coupling to a deck of a boat such that a control pedal of a trolling motor of the boat is disposed within an internal portion of the body of the mountable stand assembly.

In various embodiments, the first side support frame includes a first flanged surface bent inward from a bottom portion of the first side support frame toward a first side of the control pedal and operable to contact the deck of the boat.

In various embodiments, the second side support frame includes a second flanged surface bent inward from a bottom portion of the second side support frame toward a second side of the control pedal and operable to contact the deck of the boat.

In various embodiments, the first flanged surface of the first side support frame includes a first plurality of bolt slots operable to receive bolts to couple the first side support frame to the deck of the boat.

In various embodiments, the second flanged surface of the second side support frame includes a second plurality of bolt slots operable top receive bolts to couple the second side support frame to the deck of the boat.

In various embodiments, the front side support frame includes a third flanged surface disposed on a first side of the front side support frame adjacent to the first side support frame, the third flanged surface bent inward from the first side of the front side support frame toward the control pedal, the third flanged surface including a third plurality of bolt holes operable to receive bolts to couple the front side support frame to the first side support frame.

In various embodiments, the front side support frame includes a fourth flanged surface disposed on a second side of the front side support frame adjacent to the second side support frame, the fourth flanged surface bent inward from the second side of the front side support frame toward the control pedal, the fourth flanged surface including a fourth plurality of bolt holes operable to receive bolts to couple the front side support frame to the second side support frame.

In various embodiments, the front side support frame includes a trolling motor passage formed as a cutout along a bottom side of the front side support frame.

In various embodiments, each of a plurality of sides of the standing surface includes a standing surface flanged surface bent in an outward direction away from the control pedal, and wherein each standing surface flanged surface includes a plurality of bolt holes operable to receive bolts to couple the standing surface to each of the front side support frame, the first side support frame, and the second side support frame.

In various embodiments, the foot passage is formed as a U-shaped cutout.

In various embodiments, each corner of the standing surface has a rounded or curved outer facing surface.

In various embodiments, a mountable stand assembly includes a body, wherein the mountable stand assembly is operable for coupling to a deck of a boat such that a control pedal of a trolling motor of the boat is disposed within an internal portion of the body. The body includes a first side support frame, wherein the first side support frame includes a first flanged surface bent inward from a bottom portion of the first side support frame toward a first side of the control pedal and operable to contact the deck of the boat, and wherein the first flanged surface of the first side support frame includes a first plurality of bolt slots operable to receive bolts to couple the first side support frame to the deck of the boat. The body further includes a second side support frame, wherein the second side support frame includes a second flanged surface bent inward from a bottom portion of the second side support frame toward a second side of the control pedal and operable to contact the deck of the boat, and wherein the second flanged surface of the second side support frame includes a second plurality of bolt slots operable top receive bolts to couple the second side support frame to the deck of the boat. The body further includes a front side support frame coupled between the first side support frame and the second side support frame. The front side support frame includes a third flanged surface disposed on a first side of the front side support frame adjacent to the first side support frame, the third flanged surface bent inward from the first side of the front side support frame toward the control pedal, the third flanged surface including a third plurality of bolt holes operable to receive bolts to couple the front side support frame to the first side support frame. The front side support frame further includes a fourth flanged surface disposed on a second side of the front side support frame adjacent to the second side support frame, the fourth flanged surface bent inward from the second side of the front side support frame toward the control pedal, the fourth flanged surface including a fourth plurality of bolt holes operable to receive bolts to couple the front side support frame to the second side support frame. The front side support frame further includes a trolling motor passage formed as a semi-circular cutout along a bottom side of the front side support frame. The body further includes a standing surface coupled to each of the first side support frame, the second side support frame, and the front side support frame such that the standing surface is disposed above the first side support frame, the second side support frame, and the front side support frame. The standing surface includes a plurality of sides each including a standing surface flanged surface bent in an outward direction away from the control pedal, and wherein each standing surface flanged surface includes a plurality of bolt holes operable to receive bolts to couple the standing surface to each of the front side support frame, the first side support frame, and the second side support frame. The standing surface further includes a foot passage formed as a U-shaped cutout on a rear side of the standing surface. The standing surface further includes a raised edge bent upward from an outer edge of each of the rear side, a front side, a left side, and a right side of the standing surface. The first side support frame, the second side support frame, the front side support frame, and the standing surface each has a generally rectangular shape.

In various embodiments, a mountable stand is coupled to a deck of a boat such that a control pedal of a trolling motor of the boat is disposed inside of the mountable stand. The mountable stand includes a support frame coupled to the deck of the boat. The support frame includes a left side support frame having a generally rectangular shape, the left side support frame including a first flanged surface bent from a bottom side of the left side support frame inward toward a left side of the control pedal and contacting the deck of the boat, the first flanged surface of the left side support frame including a first plurality of bolt slots through which bolts pass to couple the left side support frame to the deck of the boat. The support frame further includes a right side support frame having a generally rectangular shape, the right side support frame including a second flanged surface bent from a bottom side of the right side support frame inward toward a right side of the control pedal and contacting the deck of the boat, the second flanged surface of the right side support frame including a second plurality of bolt slots through which bolts pass to couple the right side support frame to the deck of the boat. The support frame further includes a front side support frame coupled between each of the left side support frame and the right side support frame and having a generally rectangular shape. The front side support frame includes a third flanged surface disposed on a left side of the front side support frame adjacent to the left side support frame, the third flanged surface bent inward from the left side of the front side support frame toward a front side of the control pedal, the third flanged surface including a third plurality of bolt holes through which bolts to pass to couple the front side support frame to the left side support frame. The front side support frame further includes a fourth flanged surface disposed on a right side of the front side support frame adjacent to the right side support frame, the fourth flanged surface bent inward from the right side of the front side support frame toward the control pedal, the fourth flanged surface including a fourth plurality of bolt holes through which bolts pass to couple the front side support frame to the right side support frame. The front side support frame further includes a trolling motor passage formed as a semi-circular cutout along a bottom side of the front side support frame, the trolling motor passage configured to allow for one or more portions of the trolling motor to pass from an inside of the mountable stand to an outside of the mountable stand. The mountable stand further includes a standing surface having a generally rectangular shape and coupled to the support frame, wherein each of the left side support frame, the right side support frame, and the front side support frame includes a standing surface flanged surface bent outward away from the control pedal from a top side of the respective left side support frame, right side support frame, and front side support frame, each standing surface flanged surfaces including a respective plurality of bolt holes through which bolts pass to couple the standing surface to each of the front side support frame, the left side support frame, and the right side support frame. The standing surface includes a foot passage formed as a U-shaped cutout on a rear side of the standing surface, the foot passage formed such that a user standing on a top surface of the standing surface can pass a foot of the user through the foot passage to operate the control pedal. The standing surface further includes a raised edge bent upward from an outer edge of each of the rear side, a front side, a left side, and a right side of the standing surface, wherein each corners of the standing surface have a rounded or curved outer facing surface.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element. The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1A illustrates an example perspective view of a mountable stand assembly according to various embodiments of the present disclosure;

FIG. 1B illustrates an example front perspective view of a mountable stand assembly according to various embodiments of the present disclosure;

FIG. 1C illustrates an example top view of a mountable stand assembly according to various embodiments of the present disclosure;

FIG. 1D illustrates an example bottom view of a mountable stand assembly according to various embodiments of the present disclosure;

FIG. 1E illustrates an example left side view of a mountable stand assembly according to various embodiments of the present disclosure;

FIG. 1F illustrates an example right side view of a mountable stand assembly according to various embodiments of the present disclosure;

FIG. 1G illustrates an example rear view of a mountable stand assembly according to various embodiments of the present disclosure;

FIG. 1H illustrates an example front view of a mountable stand assembly according to various embodiments of the present disclosure;

FIG. 2 illustrates an example of a mountable stand assembly according to various embodiments of the present disclosure mounted to a fishing boat with a trolling motor assembly;

FIG. 3A illustrates an example front perspective view of a mountable stand assembly with widened mounting lips according to various embodiments of the present disclosure;

FIG. 3B illustrates an example perspective view of a mountable stand assembly with widened mounting lips according to various embodiments of the present disclosure;

FIG. 4 illustrates an example of a mountable stand assembly with a rectangular foot passage according to various embodiments of the present disclosure;

FIG. 5 illustrates an example of a mountable stand assembly with a triangular foot passage according to various embodiments of the present disclosure; and

FIG. 6 illustrates an example of a mountable stand assembly with an oval shaped foot passage according to various embodiments of the present disclosure.

### DETAILED DESCRIPTION

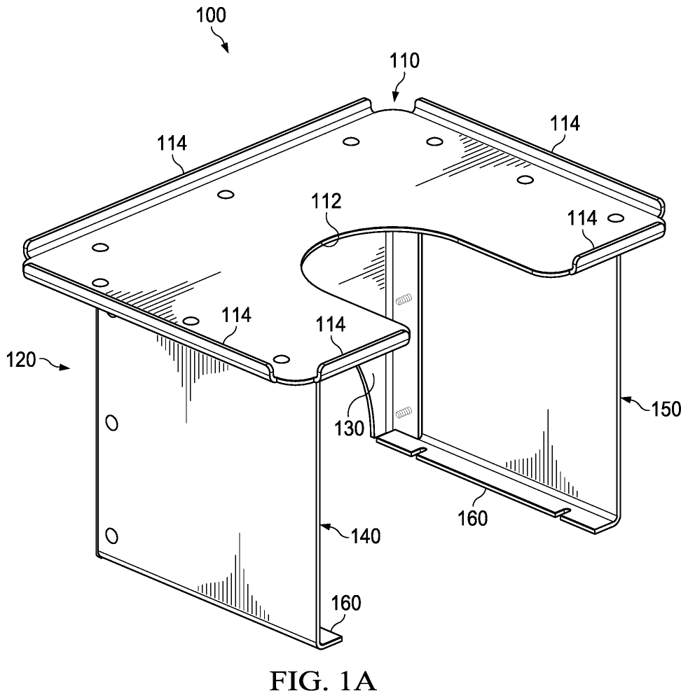

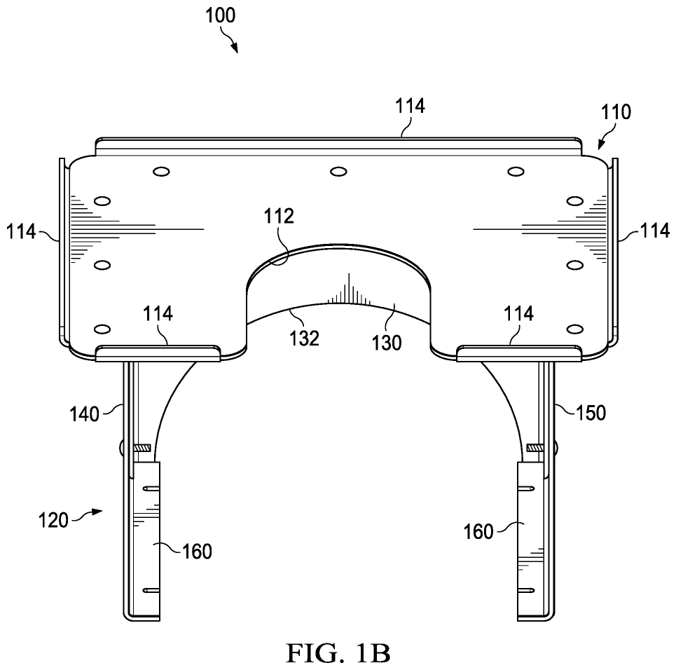

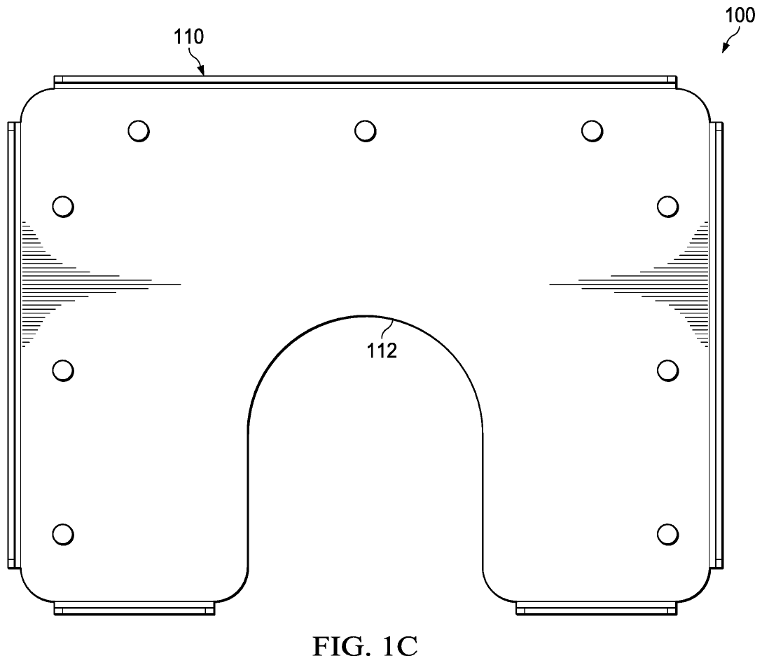

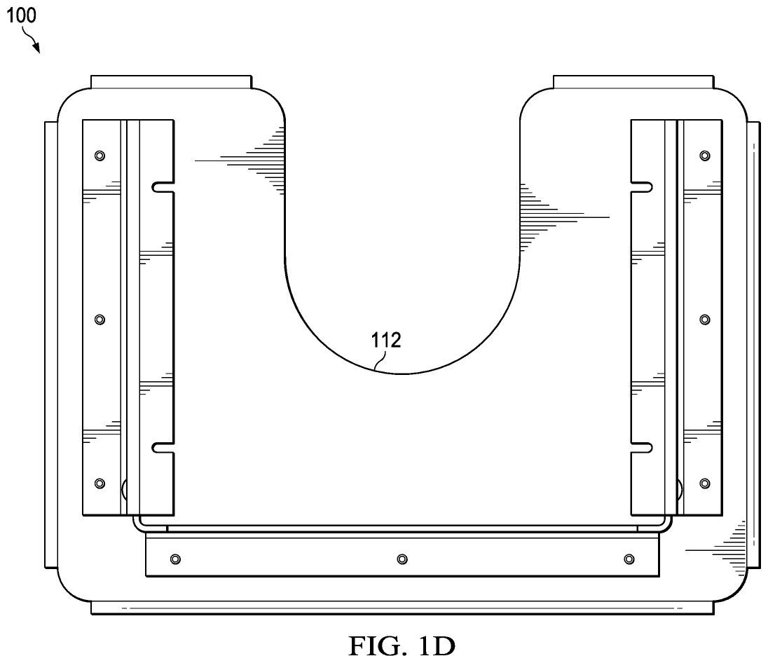

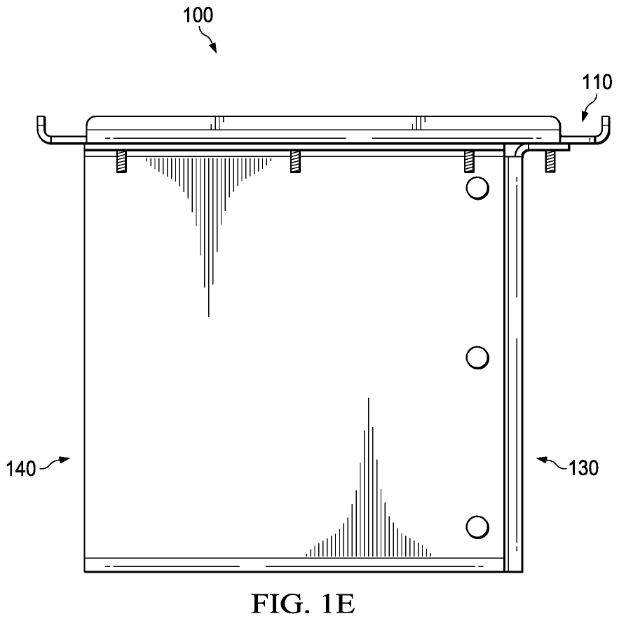

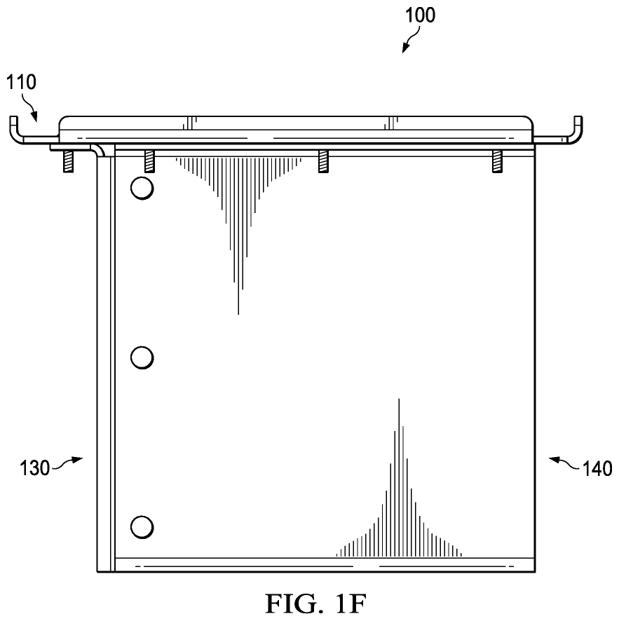

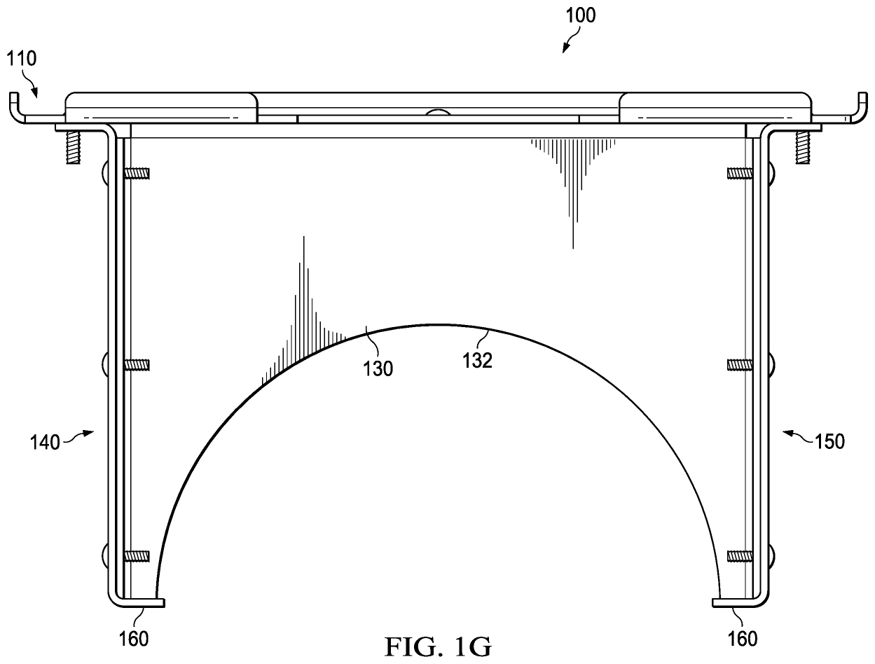

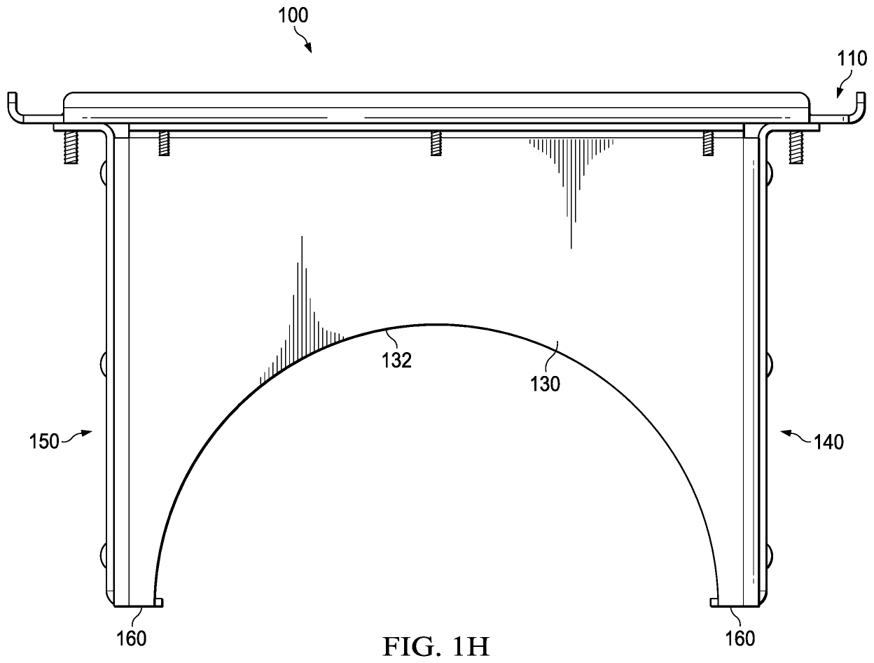

FIGS. 1A through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system, device, or apparatus.

Embodiments of the present disclosure recognize and take into account that a user may wish to stand on an elevated surface to perform various tasks or reach various items. For example, in order for bass fishers to effectively locate fish, fishers can stand on an elevated surface to gain a better vantage point of fish swimming near the surface of the water. Fishers commonly use stools, ice chests, or other items commonly found in a fishing boat as the elevated surface. In this example, in order to travel toward the located fish, the fisher must step off of the elevated surface to operate a trolling motor to move the boat to the fish. Using a stool, ice chest, or other object as an elevated surface can be dangerous, as such items are not secured to the boat and are not meant for standing on or fishing from. Using a stool, ice chest, or other object as an elevated surface can be impractical, as the fisher must go back and forth between the elevated surface and the trolling motor pedal when approaching a group of fish.

Accordingly, embodiments of the present disclosure recognize that there is a need for a mountable stand that can be used by fishers in some embodiments to safely obtain an advantageous vantage point and to also operate the boat's trolling motor.

FIG. 1A illustrates an example perspective view of a mountable stand assembly 100 according to various embodiments of the present disclosure. FIG. 1B illustrates an example front perspective view of a mountable stand assembly according to various embodiments of the present disclosure. FIG. 1C illustrates an example top view of a mountable stand assembly 100 according to various embodiments of the present disclosure. FIG. 1D illustrates an example bottom view of a mountable stand assembly according to various embodiments of the present disclosure. FIG. 1E illustrates an example left side view of a mountable stand assembly according to various embodiments of the present disclosure. FIG. 1F illustrates an example right side view of a mountable stand assembly 100 according to various embodiments of the present disclosure. FIG. 1G illustrates an example rear view of a mountable stand assembly 100 according to various embodiments of the present disclosure. FIG. 1H illustrates an example front view of a mountable stand assembly according to various embodiments of the present disclosure. The embodiments of the mountable stand assembly 100 shown in FIGS. 1A-1H are for illustration only. Other embodiments of the mountable stand assembly 100 could be used without departing from the scope of this disclosure.

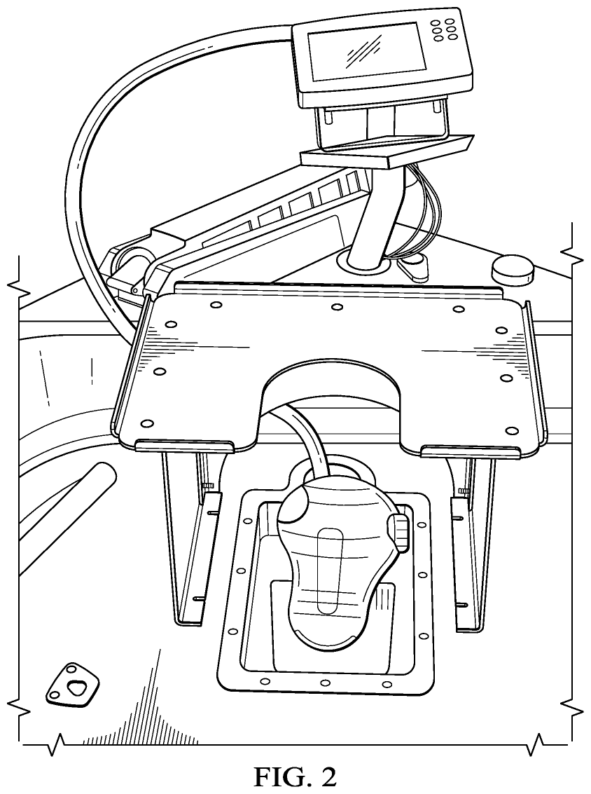

The example mountable stand assembly 100 includes a body having a standing surface 110 and a standing surface support frame 120. The standing surface support frame 120 includes a front support frame 130, a first side support frame 140, and a second side support frame 150. The support frame 120 can be mounted to a surface of a structure to provide that the standing surface 110 is stable and secure for a user to stand on the standing surface 110. For example, as illustrated in FIG. 2 and discussed in greater detail below, in some embodiments the support frame 120 can be mounted to a surface of a fishing boat around a pedal of a trolling motor. In this position, a fisher can stand on the standing surface 110 while also being able to access the trolling motor.

The standing surface 110 may be formed from any of a number of materials. In some embodiments, the standing surface 110 may be formed of a metal plate. In some embodiments, the standing surface 110 may be formed of a plastic or composite material. One having skill in the art will recognize that the standing surface may be formed from any number of materials without departing from the scope of the disclosure.

The standing surface 110 is formed so that a user may stand on a top surface of the standing surface 110 to gain a better vantage point, such as to spot fish swimming close to the surface of a body of water. The top surface of the standing surface 110 may be formed to have a resistance so that friction is created with the user's feet. The resistance of the top surface may be formed by any of a number of methods. In some embodiments, the top surface of the standing surface may be formed to have a plurality of bumps so that the top surface is not completely flat and friction can be formed with the user's feet. In some embodiments, portions of the top surface may be cut out from the top surface so that the top surface is not completely flat and friction can be formed with the user's feet. In some embodiments, through holes may be formed in the top surface such that friction can be formed with the user's feet. In some embodiments a slip resistant material can be coupled to the top surface such that friction can be formed with the user's feet. One having skill in the art will recognize that friction can be formed between the user's feet and the top surface of the standing surface 110 by any number of structures or methods without departing from the scope of the present disclosure.

As illustrated in FIGS. 1A-1H, the standing surface 110 may be formed to have generally a square or rectangular shape. The square or rectangular shaped standing surface 110 thus can have four different sides defining the structure of the standing surface. The standing surface 110 may have a front side, a rear side, a left side, and a right side. One having skill in the art will recognize that the standing surface 110 is not limited to a generally square or rectangular shape. In some embodiments, the standing surface 110 may be any other quadrilateral shape. In some embodiments, the standing surface 110 may have a round, circular, or oval shape. In some the standing surface 110 may have a triangular shape. One having skill in the art will understand that the standing surface 110 is not limited to described shapes and that the standing surface 110 may be formed to have any shape without departing from the scope of the disclosure.

The standing surface 110 may comprise a foot passage or cutout 112. As will be discussed in greater detail below with reference to FIG. 2, in some embodiments, a user may stand on a top surface of the standing surface 110 such that the user's two feet are disposed such that the user's toes are adjacent to the frontside of the standing surface 110 and the user's heels are adjacent to the rear side of the standing surface. In this position, the user's left foot is adjacent to the left side of the standing surface 110 and the user's right foot is adjacent to the right side of the standing surface 110. In this position, the user's two feet can straddle the foot passage 112.

As shown in FIGS. 1A-1D, the foot passage 112 can be a cutout or aperture formed in the standing surface 110. The foot passage 112 can be a cutout from the rear side of the standing surface 110 toward the center of the standing surface 110. The cutout of the foot passage 112 can comprise any of a number of shapes. As illustrated in FIGS. 1A-1D, the foot passage or cutout 112 can be a U-shaped cutout. In other embodiments, the cutout may be a rectangular shape, a triangular shape, a circular shape, an oval shape, or any other shape suitable for a user's foot to pass from above the standing surface 110 to below the standing surface 110. One having skill in the art will understand that the foot passage 112 cutout is not limited to the shapes described and may be formed as any other shape without departing from the scope of the disclosure.

FIGS. 1A-1D illustrate the cutout foot passage 112 is formed in the rear side of the standing surface 110. In another embodiment, the cutout foot passage 112 is formed in the front side of the standing surface 110. In another embodiment, the cutout foot passage 112 is formed in the right side of the standing surface 110. In another embodiment, the cutout foot passage 112 is formed in the left side of the standing surface 110.

FIGS. 1A-1D illustrate that the foot passage 112 is cut out from a side of the standing surface 110. However, one having skill in the art will recognize that the foot passage 112 is not limited to a cutout. In another embodiment, the foot passage 112 may be a through hole formed in the standing surface. For example, the foot passage 112 may be a hole surrounded on all sides by the standing surface 110. The foot passage 112 hole may be formed in any shape. The foot passage 112 through hole can be a U-shaped through hole. In other embodiments, the through hole may be a rectangular shape, a triangular shape, a circular shape, an oval shape, or any other shape suitable for a user's foot to pass from above the standing surface 110 to below the standing surface 110.

As illustrated in FIGS. 1A-1H, each of the front side, rear side, left side, and right side of the standing surface 110 may include a raised edge 114 extended in an upward direction from the top surface of the standing surface 110. The raised edges 114 are meant to contain the user's feet within the bounds of the standing surface 110. When the user is standing on the standing surface 110, he may be focused on a number of different things, such as reaching for an object, viewing the user's surroundings such as locating fish, or performing other tasks such as casting a fishing line, reeling in a fish, accessing an item through the foot passage 112 such as pressing a button or operating a trolling motor, or any of a number of other tasks. While the user is focused on these other tasks, the user may lose track of his position on the standing surface 110. The raised edges 114 allow the user to feel with his feet where the bounds of the standing surface 110 are. Additionally, the raised edges 114 are raised to a height past the top surface of the standing surface 110 to prevent the user's feet from sliding off of the standing surface 110.

As illustrated in FIGS. 1A-1H, the raised edges 114 may be edges of the standing surface 110 that are bent upward. However, one having skill in the art will recognize that the raised edges 114 are not limited to being bent portions of the standing surface 110. In other embodiments, the raised edges 114 may be pieces that are not integrally formed with the standing surface and are coupled to the standing surface. In some embodiments, the raised edges 114 may be pieces that are coupled to the top surface or to edges of the standing surface 110. The raised edges 114 may be coupled to the standing surface by any of a number of suitable techniques. In various embodiments, the raised edges 114 may be coupled to the standing surface 110 with screws, bolts, rivets, or any other suitable fastening member. In various embodiments, the raised edges 114 may be coupled to the standing surface 110 by welding or adhesion.

As illustrated in FIGS. 1A-1D, in some embodiments the raised edges 114 are not disposed on the corners of the standing surface 110. This allows for the corners of the standing surface 110 to easily drain any water or other fluid that may accumulate on the standing surface 110. The corners being free from the raised edges 114 also enables an eased manufacturing process when the raised edges 114 are bent from the standing surface 110, as illustrated in the figures. However, one having skill in the art will understand that the raised edges 114 can extend to cover the corners of the standing surface 110 without departing from the scope of the disclosure.

As illustrated in FIGS. 1A-1D, the corners of the standing surface 110 may be curved corners. FIGS. 1A-1D also illustrate that the four outer corners of the standing surface 110 have a curved outer facing surface. FIGS. 1A-1D also illustrate that the two corners between the rear side of the standing surface 110 and the foot passage 112 cutout have a curved outer facing surface. The corners of the standing surface 110 are curved to prevent any potential injury to the user. The user could possibly brush against a corner of the standing surface 110 when walking near the mountable stand assembly 100, such as around a deck of a boat, or when standing on top of the standing surface and reaching through the foot passage 112, such as to operate the trolling motor pedal, as will be discussed in greater detail below. The curved corners lessen the chance of the user being scratched or injured by the standing surface 110 in the event the user brushes up against one of the corners. However, one having skilled on the art will understand that the corners of the standing surface 110 do not have to be curved to comply the scope of the disclosure.

The standing surface 110 may be coupled to the support frame 120. As illustrated in FIGS. 1A-1H, the standing surface 110 is coupled to the support frame 120 by bolts. Although FIGS. 1A-1H illustrate that the standing surface 110 is coupled to the support frame 120, one having skill in the art will recognize that the standing surface 110 can be integrally formed with the support frame 120 without departing from the scope of the invention.

The standing surface 110 can be removably coupled to the support frame 120. For example, as illustrated in FIGS. 1A-1H, bolts may be used to couple the standing surface 110 to the support frame 120. By being removably coupled, the standing surface 110 may be removed from the support frame 120. This may be advantageous for a number of different reasons. For example, a user may remove the standing surface 110 from the support frame 120 so that the user can access an object or apparatus below the standing surface 110, such as the trolling motor pedal so that maintenance can be performed on the pedal. Also, by being removably coupled, the standing surface 110 can be interchangeable with another standing surface. For example, a user may want to switch the standing surface 110 mounted to the support frame 120 depending on the environment. By being removably coupled to the support frame 120, the user may have various standing surfaces that he can interchange with a single support frame 120.

FIGS. 1A-1H illustrate that the standing surface 110 is removably coupled to the support frame 120 by bolts. However, one having skill in the art will understand that the standing surface 110 may be removably coupled to the support frame by any of a number of methods or structures without departing from the scope of the disclosure. For example, the standing surface 110 may comprise a locking structure that mates with a corresponding locking structure of the support frame 120 to couple the standing structure to the support frame. Additionally, the standing surface 110 may be coupled to the support frame 120 by any other method without departing from the scope of the invention. For example, the standing surface 110 can be welded or adhered to the support frame 120. Additionally, one having skill in the art will understand that the standing surface 110 and the support frame 120 can be integrally formed as a single piece without departing from the scope of this disclosure.

Referring to FIGS. 1A-1H, the support frame 120 will now be described. The support frame 120 can include a front side support frame 130, a first side support frame 140, and a second side support frame 150. The first side support frame 140 may also be referred to as a right side support frame herein. The second side support frame 150 may also be referred to as a left side support frame herein.

As illustrated in FIGS. 1A-1H, each of the support frames 130, 140, and 150 may include a coupling surface disposed at a top side of each of the support frames 130, 140, and 150 and to which the standing surface 110 is coupled. The coupling surface may be a flanged surface. The flanged surface may be portion of each of support frames 130, 140, and 150 bent outward in a direction away from a center of the standing surface 110. The flanged surface of each of the support frames 130, 140, and 150 may include a plurality of bolt holes so that the standing surface 110 can be bolted to the flanged surface of each of the support frames 130, 140, and 150. Although FIGS. 1A-1H illustrate that each of the support frames 130, 140, and 150 are coupled to the standing surface 110, one having skill in the art will recognize that there may be other embodiments in accordance with the disclosure in which some of the support frames 130, 140, and 150 are not coupled to the standing surface 110. For example, in one embodiment, the front support frame 130 may only be coupled with the right side and left side support frames 140, 150 and be disconnected from the standing surface 110.

Referring to FIGS. 1A, 1B, 1G, and 1H, the front support frame 130 may be formed from any of a number of materials. In some embodiments, the front support frame 130 may be formed of a metal plate. In some embodiments, the front support frame 130 may be formed of a plastic or composite material. One having skill in the art will recognize that the front support frame 130 may be formed from any number of materials without departing from the scope of the disclosure.

The standing front support frame 130 may be formed to have generally a square or rectangular shape. The square or rectangular shaped front support frame 130 may inherently have four different sides defining the structure of the front support frame. The front side support frame 130 may have a top side adjacent to the standing surface 110, a bottom side opposite of the top side, a right side adjacent to the first side support frame 140, and a left side adjacent to the second side support frame 150.

In addition to being coupled to the standing surface 110, the support frame 130 can be coupled to the each of the first side support frame 140 and the second side support frame 150. Referring to FIGS. 1A, 1B, 1G, and 1H, the left side of the front support frame 130 includes a flanged surface with bolt holes so that bolts can be used to couple the front support frame 130 to second side support frame 150. The right side of the support frame 130 includes a flanged surface with bolt holes so that bolts can be used to couple the front support frame 130 to the first support frame 140.

The front support frame 130 may include an object passage 132. As will be described in greater detail below, in some embodiments the mountable stand assembly 100 can be mounted to a deck of a boat to cover a trolling motor pedal. A wire electrically connects the pedal to the trolling motor so that the motor can be controlled by the fisher's operation of the pedal. The object passage 132 can therefore be a trolling motor passage that enables the pedal control wire to pass between the pedal under the stand assembly 100 and the trolling motor disposed outside of the stand assembly 100. Additionally, depending on the layout and geometry of the boat, the trolling motor pedal, and the trolling motor, the trolling motor pedal may be disposed very close to the trolling motor mounting piece that mounts the motor to the bow of the boat. In this case, a part of the trolling motor mounting piece may be disposed within the object passage 132 to enable the stand assembly 100 to be mounted to the deck of the boat.

The object passage 132 can be a cutout formed in the front side support member 130. The object passage 132 is cutout from the bottom side of the of the front side support member toward the center of the front side support member 130. The cutout of the object passage 132 can comprise any of a number of shapes. As illustrated in FIGS. 1A-1D, the foot passage 112 cutout can be a semi-circle cutout. In other embodiments, the cutout may be a rectangular shape, a triangular shape, a circular shape, an oval shape, or any other shape suitable for accommodating the pedal control wire, trolling motor mounting piece, or any other part of the trolling motor disposed in the cutout. One having skill in the art will understand that the object passage 132 cutout is not limited to the shapes described and may be formed as any other shape without departing from the scope of the disclosure.

FIGS. 1A, 1B, 1G, and 1H illustrate that the object passage 132 is cut out from a side of the front support frame 130. However, one having skill in the art will recognize that the object passage 132 is not limited to a cutout. In another embodiment, the object passage 132 may be a through hole formed in the front support frame 130. For example, object passage 132 may be a hole surrounded on all sides by the front support frame 130. The object passage 132 may be formed in any shape. The object passage 132 through hole can be a circular shaped through hole. In other embodiments, the through hole may be a rectangular shape, a triangular shape, an oval shape, or any other shape suitable for the trolling motor pedal wire to pass between the trolling motor pedal disposed under the mountable stand assembly 100 and the trolling motor disposed outside of the mountable stand assembly 100.

Referring to FIGS. 1A, 1B, and 1E-1H, the right side and left side support frames 140, 150 may be formed from any of a number of materials. In some embodiments, the front support frame 130 may be formed of a metal plate. In some embodiments, the right side and left side support frame 140, 150 may be formed of a plastic or composite material. One having skill in the art will recognize the right side and left side support frame 140, 150 may be formed from any number of materials without departing from the scope of the disclosure.

The right side and left side support frame 140, 150 may each be formed to have generally a square or rectangular shape. The square or rectangular shaped right side and left side support frame 140, 150 may each inherently have four different sides defining the structure of the support frame. Each of right side and left side support frame 140, 150 may have a top side adjacent to the standing surface 110, a bottom side opposite of the top side, a front side adjacent to the front side support frame 130, and a rear side opposite of the front side.

As previously described, the right side and left side support frame 140, 150 can be coupled to the standing surface 110. As also previously described, the front side of each of the right side and left side support frame 140, 150 can be coupled to the front support frame 130. The front side of each or the right side and left side support frame 140, 150 may comprise a plurality of bolt holes so that bolts can be passed through the bolt holes to couple the right side and left side support frame 140, 150 to the front side support frame 130. Additionally, the right side and left side support frame 140, 150 may be coupled to the front side support frame 130 by any other method without departing from the scope of the invention. For example, each of the right side and left side support frame 140, 150 can be welded or adhered to the front side support frame 130.

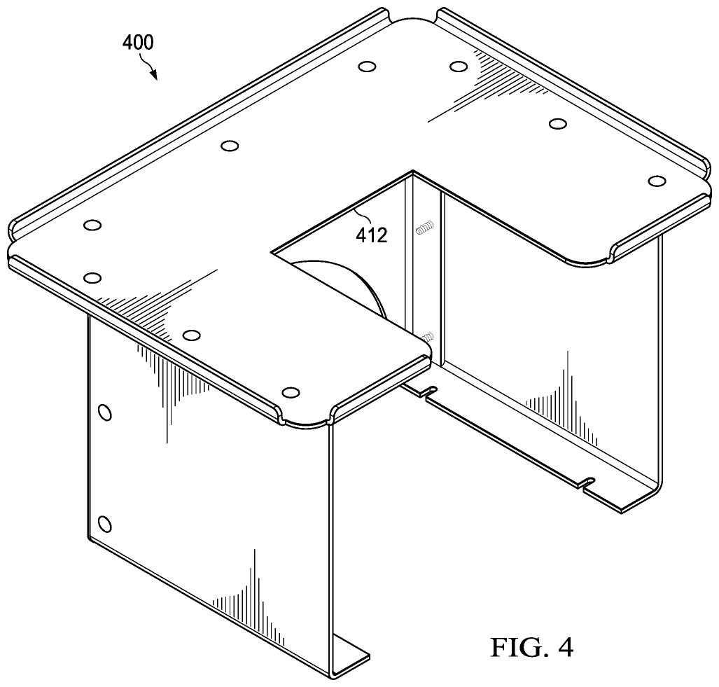

In some embodiments, a bottom side of each of the right side and left side support frame 140, 150 may include a coupling section configured to be used to couple the right side and left side support frame 140, 150 to a structure such as a deck of a boat. As illustrated in FIGS. 1 and 4, the coupling section of each of the right side and left side support frame 140, 150 comprises a flanged surface bent from the respective right side and left side support frame 140, 150. The flanged surface of each of the right side and left side support frame 140, 150 is bent from the respective right side and left side support frame 140, 150 inward in a direction toward a center of the standing surface 110. The flanged surfaces each include a plurality of slots through which bolts can be passed to couple the right side and left side support frame 140, 150 to the structure. One having skill in the art will recognize that the coupling section of each of the right side and left side support frame 140, 150 may comprise any configuration that enables the right side and left side support frame 140, 150 to be coupled to the deck of the boat. For example, the coupling sections may include interlocking formations configured to interlock with mating formations disposed on a deck of a boat. Additionally, one having skill in the art will recognize that the coupling sections can be welded or adhered to the structure, such as the deck of the boat. The coupling section of each of the right side and left side support frame 140, 150 may be coupled to the structure by any method without departing from the scope of the disclosure. Additionally, in some embodiments, one having skill in the art will understand that the right side and left side support frame 140, 150 are not coupled to the structure, but instead are held in place by friction between the structure, such as the deck of the boat, and the right side and left side support frame 140, 150. Additionally, in some embodiments, the front support frame 130 can be coupled to the structure by any of the methods and configurations previously described.

The figures illustrate the support frame 120 is formed of separate frames 130, 140, 150 having plate-like forms. However, one skill in the art will understand that support frame 120 can have any of a number of different forms without departing from the scope of the disclosure. For example, in an embodiment, instead of being formed by a plurality of separate pieces, the support frame 120 may be integrally formed as a single piece. Additionally, in one embodiment, the support frame 120 be comprised of a plurality of columns, each with one end coupled to the standing surface 110 and with the other end coupled to the structure. In one embodiment, there may be four such columns, where one column is disposed at each of the four corners of the standing surface 110.

FIG. 2 illustrates an example of a mountable stand assembly 100 according to various embodiments of the present disclosure mounted to a fishing boat with a trolling motor assembly. It may be advantageous to set forth definitions of certain words and phrases used throughout this patent document. The right side and left side support frames 140, 150 of the stand 100 are coupled to the deck of the boat as previously described. As illustrated in FIG. 2, the first side support frame 140 is coupled to the deck to the right of the trolling motor pedal and the left side support frame 150 is coupled to the deck to the left of the trolling motor pedal. In other words, the right side and left side support frames 140, 150 are coupled to the deck of the boat such that the trolling motor pedal is disposed between the right side and left side support frames 140, 150.

Additionally, the right side and left side support frames 140, 150 are coupled to the deck of the boat such that the trolling motor pedal is disposed on an inner side of front support frame 130. In other words, the fishing stand is coupled to the boat such that the pedal is housed inside of the stand 100 and does not extend past the front support frame 130. As illustrated in FIG. 2, only the pedal controlling wire that connects the pedal to the trolling motor extends from an inside of the stand 100 to an outside of the stand 100. The pedal controlling wire is connected to the pedal inside of the stand 100 and extends through the object passage 132 to an outside of the stand 100.

As previously described, a fisher can stand on the standing surface 110 such that his feet straddle the foot passage 112. In this position, the fisher can access and control the trolling motor pedal while standing on the standing surface 110. The fisher can reach either his left or right foot downward through the foot passage 112 and control the trolling motor pedal with his foot while his other foot remains on the standing surface 110. That is, the fisher may reach his foot down through the foot passage 112 to access the trolling motor pedal disposed inside of the stand 100. In this way, the fisher may control the trolling motor while still standing on the stand 100.

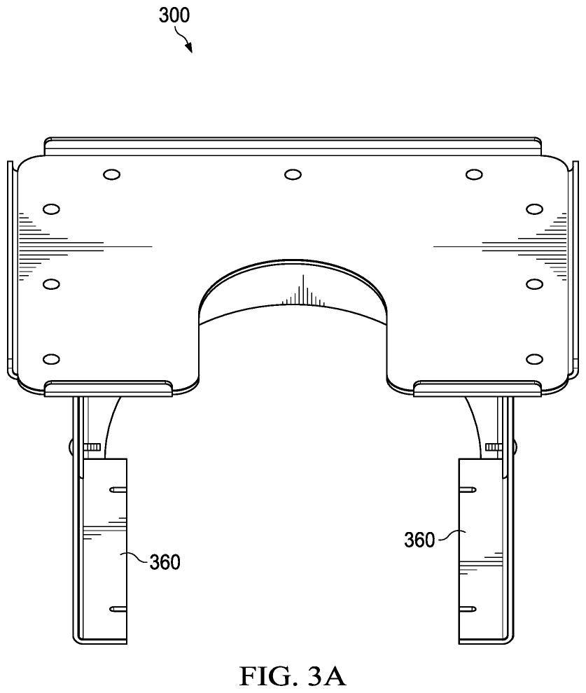

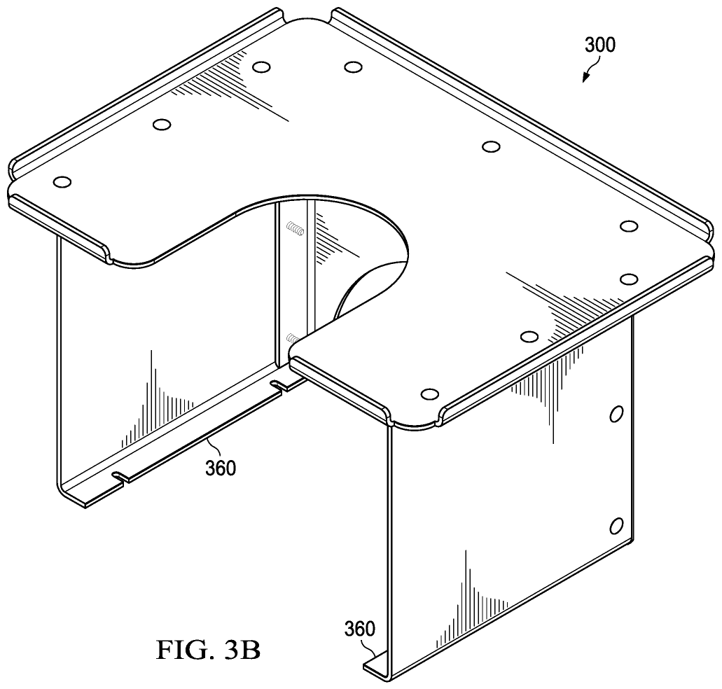

The various embodiments of the mountable stand assembly disclosed herein allow for alterations of certain portions of the mountable stand assembly. For example, FIGS. 3A and 3B illustrate an example of a mountable stand assembly 300 with widened mounting lips 360 according to various embodiments of the present disclosure. Mounting lips 360 used to mount the mountable stand assembly 300 to a surface can be widened or enlarged to provide additional structural stability when the mountable stand assembly 100 is mounted to a surface.

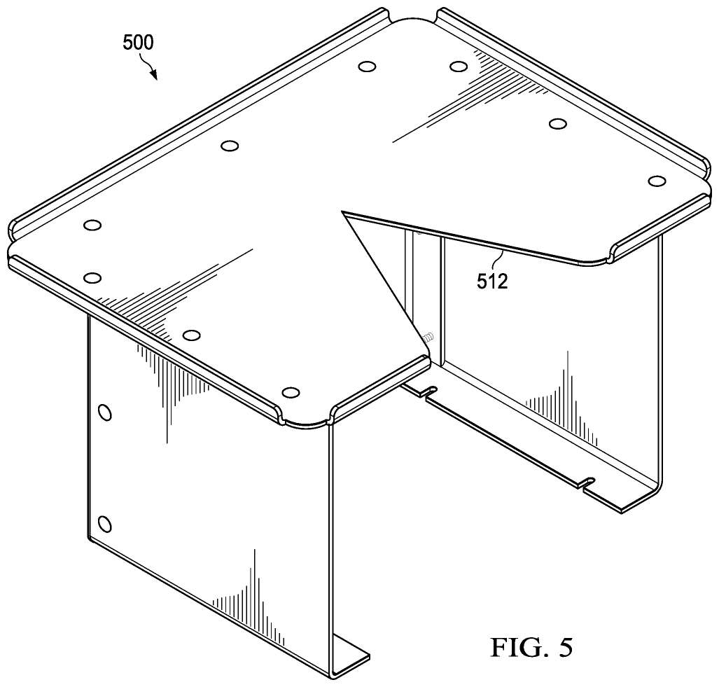

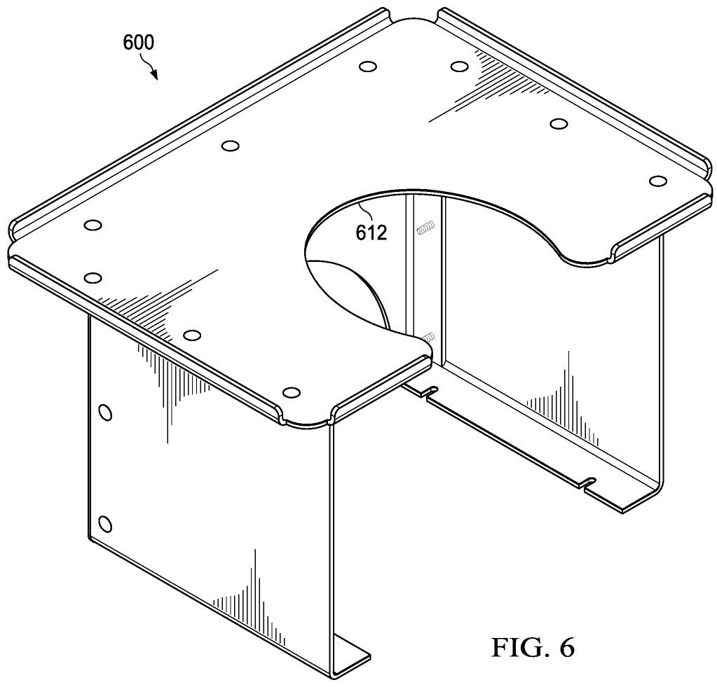

As another example, the shape of the foot passage 112 can be different in accordance with the various embodiments disclosed herein. For example, FIG. 4 illustrates an example of a mountable stand assembly 400 with a rectangular foot passage 412 according to various embodiments of the present disclosure. As another example, FIG. 5 illustrates an example of a mountable stand assembly 500 with a triangular foot passage 512 according to various embodiments of the present disclosure. As yet another example, FIG. 6 illustrates an example of a mountable stand assembly 600 with an oval shaped foot passage 612 according to various embodiments of the present disclosure. It will be understood that other components of the mountable stand assembly such as the standing surface, the raised edges, and/or the left side and right side support frames can also be of different dimensions or shapes without departing from the scope of the present disclosure.

Although this disclosure has been described with example embodiments, various changes and modifications may be suggested to one skilled in the art. It is intended that this disclosure encompass such changes and modifications as fall within the scope of the appended claims.

What is claimed is:

1. A mountable stand assembly comprising:
a body including:
a first side support frame;
a second side support frame;
a front side support frame coupled between the first side support frame and the second side support frame; and
a standing surface coupled to each of the first side support frame, the second side support frame, and the front side support frame such that the standing surface is disposed above the first side support frame, the second side support frame, and the front side support frame, the standing surface including:
a foot passage formed on a rear side of the standing surface, and
a raised edge bent upward from an outer edge of each of the rear side, a front side, a left side, and a right side of the standing surface.

2. The mountable stand assembly of claim 1, wherein the first side support frame, the second side support frame, the front side support frame, and the standing surface each has a generally rectangular shape.

3. The mountable stand assembly of claim 1, wherein the first side support frame includes a first flanged surface bent in a first inward direction from a bottom portion of the first side support frame towards a center portion of the body.

4. The mountable stand assembly of claim 3, wherein the second side support frame includes a second flanged surface bent in a second inward direction from a bottom portion of the second side support frame towards the center portion of the body.

5. The mountable stand assembly of claim 4, wherein the front side support frame includes:
a third flanged surface disposed on a first side of the front side support frame adjacent to the first side support frame, the third flanged surface bent inward from the first side of the front side support frame toward the center portion of the body; and
a fourth flanged surface disposed on a second side of the front side support frame adjacent to the second side support frame, the fourth flanged surface bent inward from the second side of the front side support frame toward the center portion of the body.

6. The mountable stand assembly of claim 1, wherein the front side support frame includes a trolling motor passage formed along a bottom side of the front side support frame.

7. The mountable stand assembly of claim 6, wherein the trolling motor passage is formed as a semi-circular cutout.

8. The mountable stand assembly of claim 1, wherein the foot passage is formed as a U-shaped cutout.

9. The mountable stand assembly of claim 1, wherein the mountable stand assembly is operable for coupling to a deck of a boat such that a control pedal of a trolling motor of the boat is disposed within an internal portion of the body of the mountable stand assembly.

10. The mountable stand assembly of claim 9, wherein the first side support frame includes a first flanged surface bent inward from a bottom portion of the first side support frame toward a first side of the control pedal and operable to contact the deck of the boat.

11. The mountable stand assembly of claim 10, wherein the second side support frame includes a second flanged surface bent inward from a bottom portion of the second side support frame toward a second side of the control pedal and operable to contact the deck of the boat.

12. The mountable stand assembly of claim 11, wherein the first flanged surface of the first side support frame includes a first plurality of bolt slots operable to receive bolts to couple the first side support frame to the deck of the boat.

13. The mountable stand assembly of claim 12, wherein the second flanged surface of the second side support frame includes a second plurality of bolt slots operable top receive bolts to couple the second side support frame to the deck of the boat.

14. The mountable stand assembly of claim 13, wherein the front side support frame includes:
a third flanged surface disposed on a first side of the front side support frame adjacent to the first side support frame, the third flanged surface bent inward from the first side of the front side support frame toward the control pedal, the third flanged surface including a third plurality of bolt holes operable to receive bolts to couple the front side support frame to the first side support frame.

15. The mountable stand assembly of claim 14, wherein the front side support frame includes:
a fourth flanged surface disposed on a second side of the front side support frame adjacent to the second side support frame, the fourth flanged surface bent inward from the second side of the front side support frame toward the control pedal, the fourth flanged surface including a fourth plurality of bolt holes operable to receive bolts to couple the front side support frame to the second side support frame.

16. The mountable stand assembly of claim 15, wherein the front side support frame includes a trolling motor passage formed as a cutout along a bottom side of the front side support frame.

17. The mountable stand assembly of claim 16, wherein each of a plurality of sides of the standing surface includes a standing surface flanged surface bent in an outward direction away from the control pedal, and wherein each standing surface flanged surface includes a plurality of bolt holes operable to receive bolts to couple the standing surface to each of the front side support frame, the first side support frame, and the second side support frame.

18. The mountable stand assembly of claim 17, wherein the foot passage is formed as a U-shaped cutout.

19. The mountable stand assembly of claim 1, wherein each corner of the standing surface has a rounded or curved outer facing surface.

20. A mountable stand assembly comprising:
a body, wherein the mountable stand assembly is operable for coupling to a deck of a boat such that a control pedal of a trolling motor of the boat is disposed within an internal portion of the body, wherein the body includes:
a first side support frame, wherein the first side support frame includes a first flanged surface bent inward from a bottom portion of the first side support frame toward a first side of the control pedal and operable to contact the deck of the boat, and wherein the first flanged surface of the first side support frame includes a first plurality of bolt slots operable to receive bolts to couple the first side support frame to the deck of the boat;
a second side support frame, wherein the second side support frame includes a second flanged surface bent inward from a bottom portion of the second side support frame toward a second side of the control pedal and operable to contact the deck of the boat, and wherein the second flanged surface of the second side support frame includes a second plurality of bolt slots operable top receive bolts to couple the second side support frame to the deck of the boat;
a front side support frame coupled between the first side support frame and the second side support frame, wherein the front side support frame includes:
a third flanged surface disposed on a first side of the front side support frame adjacent to the first side support frame, the third flanged surface bent inward from the first side of the front side support frame toward the control pedal, the third flanged surface including a third plurality of bolt holes operable to receive bolts to couple the front side support frame to the first side support frame;
a fourth flanged surface disposed on a second side of the front side support frame adjacent to the second side support frame, the fourth flanged surface bent inward from the second side of the front side support frame toward the control pedal, the fourth flanged surface including a fourth plurality of bolt holes operable to receive bolts to couple the front side support frame to the second side support frame; and
a trolling motor passage formed as a semi-circular cutout along a bottom side of the front side support frame; and
a standing surface coupled to each of the first side support frame, the second side support frame, and the front side support frame such that the standing surface is disposed above the first side support frame, the second side support frame, and the front side support frame, wherein the standing surface includes:
a plurality of sides each including a standing surface flanged surface bent in an outward direction away from the control pedal, and wherein each standing surface flanged surface includes a plurality of bolt holes operable to receive bolts to couple the standing surface to each of the front side support frame, the first side support frame, and the second side support frame;
a foot passage formed as a U-shaped cutout on a rear side of the standing surface, and
a raised edge bent upward from an outer edge of each of the rear side, a front side, a left side, and a right side of the standing surface, and
wherein the first side support frame, the second side support frame, the front side support frame, and the standing surface each has a generally rectangular shape.
